(19) United States
(12) Patent Application Publication
(10) Pub. No.: US 2007/0103009 A1
(43) Pub. Date: May 10, 2007

(54) Method and Structure for Integrated Energy Storage Device

(75) Inventor: Xiao (Charles) Yang, Cupertino, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Xiao (Charles) Yang, Cupertino, CA (US)

(21) Appl. No.: 11/554,515

(22) Filed: Oct. 30, 2006

Related U.S. Application Data
(60) Provisional application No. 60/732,449, filed on Oct. 31, 2005.

(51) Int. Cl. H02K 5/00; H02K 7/02; H02K 21/22

(52) U.S. Cl. 310/40 MM; 310/74; 310/153; 310/309

(57) ABSTRACT

The present invention relates to a method and device for fabricating an integrated flywheel device using semiconductor materials and IC/MEMS processes. Single crystal silicon has high energy storage/weight ratio and no defects. Single crystal silicon flywheel can operate at much higher speed than conventional flywheel. The integrated silicon flywheel is operated by electrostatic motor and supported by electrostatic bearings, which consume much less power than magnetic actuation in conventional flywheel energy storage systems. The silicon flywheel device is fabricated by IC and MEMS processes to achieve high device integration and low manufacturing cost. For the integrated silicon flywheel, high vacuum can be achieved using hermetic bonding methods such as eutectic, fusion, glass frit, SOG, anodic, covalent, etc. To achieve larger energy capacity, an array of silicon flywheels is fabricated on one substrate. Multiple layers of flywheel energy storage devices are stacked.

### CROSS-REFERENCES TO RELATED APPLICATIONS

This application claims priority to provisional patent application Ser. No. 60/732,449; filed on Oct. 31, 2005; commonly assigned, and of which is hereby incorporated by reference for all purposes.

### BACKGROUND OF THE INVENTION

A flywheel is an electromechanical battery that stores energy mechanically in the form of kinetic energy. Flywheels store energy very efficiently and energy density compared with chemical batteries. In addition to energy density, flywheel energy storage devices also offer several important advantages over chemical energy storage. The rate at which energy can be exchanged into or out of the battery is limited only by the motor-generator design. Therefore, it is possible to withdraw large amounts of energy in a far shorter time than with traditional chemical batteries. It is also possible to quickly charge flywheel devices.

Flywheel energy storage devices are not affected by temperature changes as chemical batteries nor do they suffer from the memory effect. Moreover, they are not as limited in the amount of energy they can hold. They have long life and are environmental friendly without toxic/heavy chemical. Another advantage of flywheels is that by a simple measurement of the rotation speed it is possible to know the exact amount of energy stored.

Conventional flywheel energy storage devices are intricate electromechanical control systems. They are complex and costly to construct and maintain. Furthermore, high performance flywheels deploy expensive composite materials which outgas and affect device performance. The composite materials have limited energy storage/weight ratio due to relatively low tensile strength. As a result, commercially available flywheel energy storage devices are expensive and bulky with large footprint, and have not been adopted widely in industrial applications and almost no presence in commercial and residential applications.

Thus, there is a need in the art for methods and apparatus for fabricating an integrate flywheel device with high energy storage/weight ratio, small form factor, and low cost for commercial and residential applications.

### SUMMARY OF THE INVENTION

The present invention relates to a method and device for fabricating an integrated flywheel device using semiconductor materials and IC/MEMS processes. Conventional flywheels deploy high tensile strength and light weight carbon composite materials to achieve high energy storage/weight ratio. Single crystal silicon has higher tensile stress than carbon composites and is relative light weight. With high energy storage/weight ratio and no defects, single crystal silicon is an ideal material for flywheel and can operate at much higher speed than conventional flywheel.

The integrated silicon flywheel is operated by electrostatic motor and supported by electrostatic bearings, which consume much less power than magnetic actuation in conventional flywheel energy storage systems.

The silicon flywheel device is fabricated by IC and MEMS processes to achieve high device integration and low manufacturing cost. The silicon flywheel and MEMS motor is formed by Deep Reactive Ion Etch (DRIE). Permanent magnetic material is deposited using methods such as sputter, evaporation, Physical Vapor Deposition (PVD), pulsed laser deposition, etc. Planar coils are fabricated by deposition, electroplating, photo lithography and etch.

To minimize energy loss due to friction, high vacuum is desirable in a flywheel device. For the integrated silicon flywheel, high vacuum can be achieved using hermetic bonding methods such as eutectic, fusion, glass frit, SOG, anodic, covalent, etc.

To achieve large energy capacity, an array of silicon flywheels is fabricated on a single substrate, and multiple layers of flywheel energy storage devices are stacked.

### BRIEF DESCRIPTION OF THE DRAWINGS

FIG. 1 is a simplified top-view diagram illustrating components of an integrated flywheel energy storage device according to one embodiment of the present invention.

FIG. 2 is a simplified cross section diagram illustrating components of an integrated flywheel energy storage device according to one embodiment of the present invention.

FIG. 3 is a simplified cross section diagram illustrating assembled integrated planar flywheel energy storage device according to one embodiment of the present invention.

FIG. 4 is simplified diagrams illustrating an array configuration of integrated flywheel energy storage devices according to one embodiment of the present invention.

### DETAILED DESCRIPTION OF THE INVENTION

According to the present invention, techniques for manufacturing objects are provided. More particularly, the invention provides a method and device for fabricating an integrated flywheel device using semiconductor materials and IC/MEMS processes. As illustrated in Prior Art diagrams, a conventional flywheel energy storage device has a flywheel member coupled to a permanent magnet of a motor/generator. When storing energy, the motor spins the flywheel to high speed converting electrical energy to kinetic energy. When releasing energy, the flywheel spins the generator converting kinetic energy back to electrical energy.

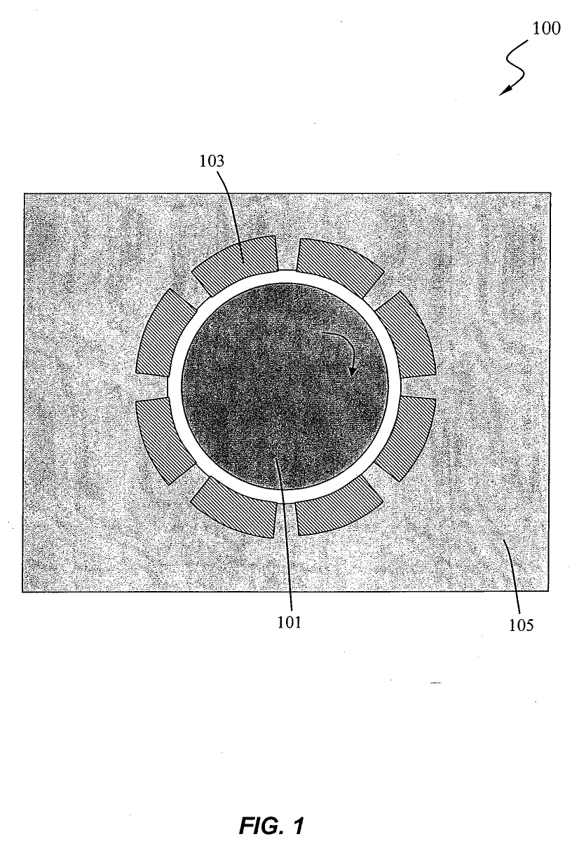

FIG. 1 is a simplified top-view diagram illustrating components of an integrated flywheel energy storage device according to one embodiment of the present invention. As illustrated, the integrated flywheel device is configured similar to an electrostatic micromotor. The flywheel 101 is actuated by the stator electrodes 103 and spins at high speed. With active feedback (capacitance sensing), 6 Degree Of Freedom (DOF) of the flywheel can be controlled and flywheel is levitated and suspended from the substrate 105. The flywheel device is fabricated on a single crystal silicon substrate using MEMS and IC processes.

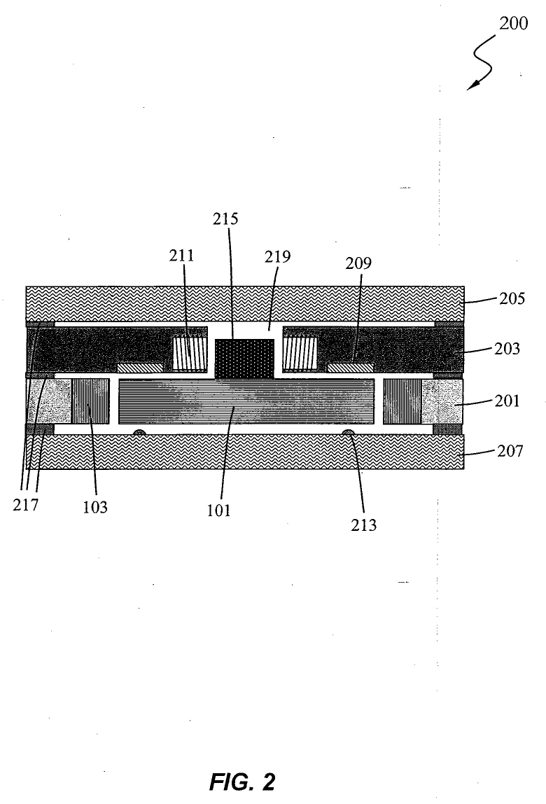

FIG. 2 is a simplified cross section diagram illustrating components of an integrated flywheel energy storage device according to one embodiment of the present invention. As illustrated, the device consists of four substrates: flywheel substrate 201, control and generator substrate 203, top housing substrate 205, and bottom housing substrate 207. The control and generator substrate consists of flywheel levitation control electrodes 209 and Copper coil winding 211. Flywheel resting supporting structures 213 are formed on the housing substrates. A permanent magnet 215 is attached to the flywheel 101. The four substrates are bonded and the chamber enclosed is hermetically sealed 217. Bonding and hermetically sealing methods include: Eutectic, Fusion, Glass frit, SOG, Anodic, Covalent, etc. Inside the chamber is a high vacuum 219 where the flywheel spins in high speed without aerodynamic friction losses.

The flywheel sits on the resting support structures 213 when system is off. During operation, the flywheel is levitated by the control electrodes 209 via electrostatic force and active position feedback, which function as electrostatic bearings. The stator electrodes 103 spin the flywheel to maximum speed converting electrical energy to kinetic energy. During discharging, the generator is turned on and electricity is generated in the Copper coil winding via interaction with the permanent magnet.

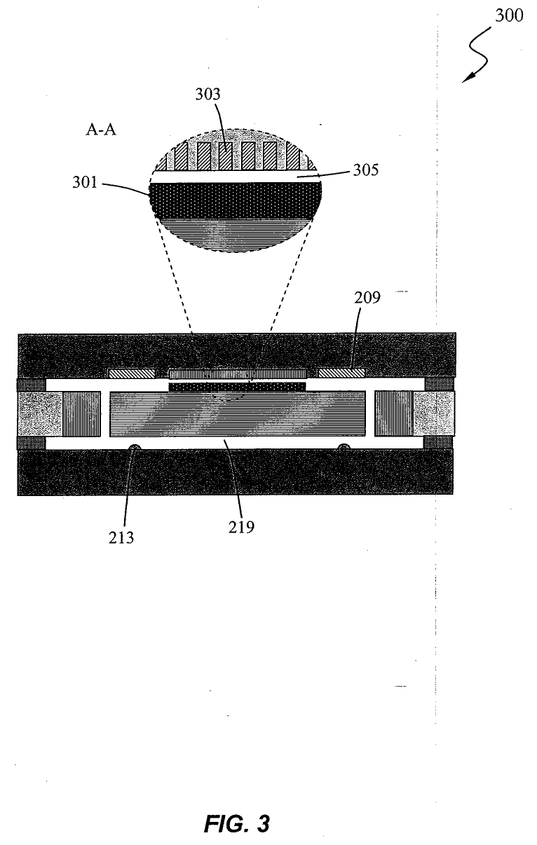

FIG. 3 is a simplified cross section diagram illustrating assembled integrated planar flywheel energy storage device according to one embodiment of the present invention. As illustrated in A-A zoomed-in view, a permanent magnetic film 301 is deposited onto the flywheel surface and planar coil 303 is formed on the generator substrate. The permanent magnetic film is coupled to the planar coil via electromagnetic interaction thru vacuum gap 305.

The flywheel sits on the resting support structures 213 when system is off. During operation, the flywheel is levitated by the control electrodes 209 via electrostatic force and active position feedback, which function as electrostatic bearings. The stator electrodes 103 spin the flywheel to maximum speed converting electrical energy to kinetic energy. During discharging, the generator is turned on and electricity is generated in the planar coils 303 via interaction with the permanent magnet film 301.

The permanent magnetic material is selected from Neodymium-iron-boron (NdFeB), Samarium Cobalt (SmCo), etc. Deposition methods include: Sputter, Evaporation, Physical Vapor Deposition (PVD), pulsed laser deposition, etc. The plan coil material is selected from Copper, Nickel, etc. Fabrication methods include: Sputter, Evaporation, Physical Vapor Deposition (PVD), electroplating, photo lithography, and etch.

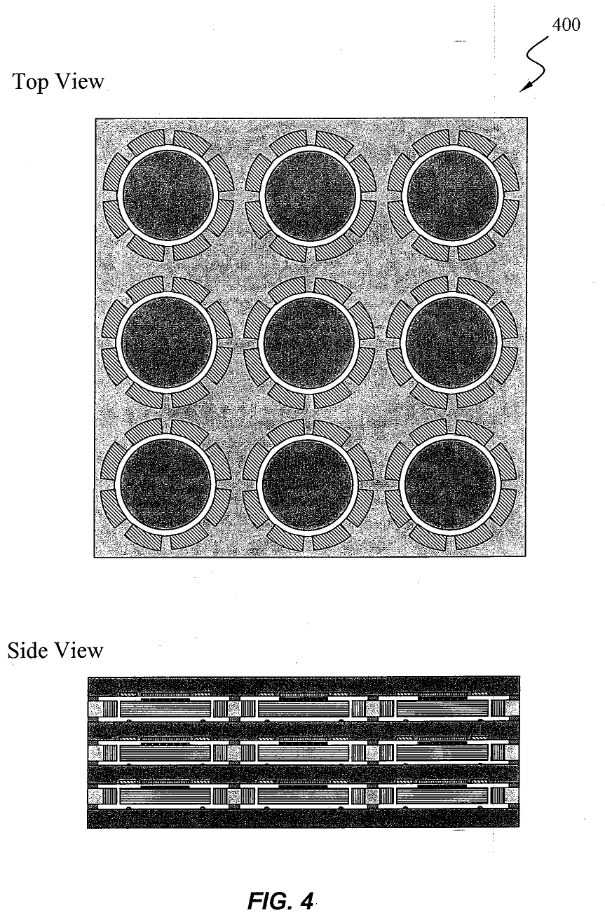

FIG. 4 is a simplified diagrams illustrating an array configuration of integrated flywheel energy storage devices according to one embodiment of the present invention. As depicted in the top view, an array of integrated flywheel energy storage devices are fabricated on a single substrate for larger capacity according to one embodiment of the present invention. According to another embodiment of the present invention, multiple layers of flywheel energy storage devices are stacked as shown in the side view diagram. Each storage device is individually operated and controlled.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A flywheel device comprising:
a substrate member, the substrate member having a thickness;
a recessed region provided within a portion of the thickness of the substrate member, the recessed region having a length and a depth within the portion of the thickness;
a rotatable member provided within the recessed region; and
one or more electrode members being spatially configured around a vicinity of the rotatable member.

2. The device of claim 1 wherein the recessed region is micromachined.

3. The device of claim 1 wherein the one or more electrode members is one or more stator devices.

4. The device of claim 1 wherein the one or more electrode members is spatially configured around a peripheral region of the recessed region.

5. The device of claim 1 wherein the recessed region is configured as a circular region.

6. The device of claim 1 wherein the recessed region is provided through an entirety of the thickness of the substrate member.

7. The device of claim 1 wherein the substrate is a single crystal silicon material.

8. The device of claim 1 wherein the rotatable member is suspended using an electrostatic force.

9. The device of claim 1 wherein the thickness is about 1 millimeter and less.

10. The device of claim 1 wherein the recessed region is 1 millimeter and less.

11. The device of claim 1 wherein the rotatable member is coupled to a permanent magnet.

12. The device of claim 1 wherein the rotatable member has a magnetic characteristic.

13. The device of claim 1 wherein the rotatable member is movable using electrostatic forces.

14. The device of claim 1 wherein the rotatable member is coupled to an electric generator device.

15. The device of claim 1 wherein the substrates comprises one or more drive circuits coupled to the one or more electrode members.

16. The device of claim 1 further comprising one or more mechanical supports to be spatially configured on one side of the rotatable member, the one or more mechanical supports being adapted to support the rotatable member while in a rest position.

17. The device of claim 1 wherein the rotatable member is enclosed under a vacuum environment.

18. The device of claim 17 wherein the enclosure is hermetically sealed provided by bonding.

19. The device of claim 18 wherein the bonding is provided by a method selected from Eutectic, Fusion, Glass frit, SOG, Anodic, or Covalent.

20. The device of claim 19 wherein the bonding is provided using wafer level packaging.

21. The device of claim 1 wherein the rotatable member comprises one or more layers of magnetic films thereon.

22. The device of claim 21 wherein the rotatable member is coupled to a plurality of inductive coils, each of the inductive coils being provided in a second substrate member, each of the plurality of coils being spatially disposed on the second substrate member, the second substrate member being operably coupled to the substrate member.

23. The device of claim 1 wherein the rotatable member is suspending. between a pair of electro-static devices.

24. The device of claim 23 wherein the electro static devices provides a bearing characteristic supporting the rotatable member, the electro static devices being coupled to sensing and active feedback control.

25. The device of claim 1 wherein the rotatable member is one of a plurality of rotatable members provided on the substrate.
